(19) United States
(12) Patent Application Publication
(10) Pub. No.: US 2010/0208387 A1
(43) Pub. Date: Aug. 19, 2010

(54) Fly-Height Management Via Harmonic Sensing

(76) Inventor: Richard M. Ehrlich, Saratoga, CA (US)

Correspondence Address: PATTERSON & SHERIDAN, L.L.P., 3040 POST OAK BOULEVARD, SUITE 1500, HOUSTON, TX, 77056, US

(21) Appl. No.: 12/389,099

(22) Filed: Feb. 19, 2009

(51) Int. Cl. G11B 33/14

(52) U.S. Cl. 360/97.02; G9B/33.035

(57) ABSTRACT

In a disk drive, the fly-height of a recording head with respect to a recording medium is adjusted such that a target magnetic separation between the recording head and the recording medium is achieved. The target magnetic separation is determined based on the operating temperature of the disk drive. In addition, different target magnetic separations may be determined for different radial locations of the recording medium.

### BACKGROUND OF THE INVENTION

1. Field of the Invention

Embodiments of the present invention relate generally to magnetic disk drives and, more particularly, to a method of fly-height management via harmonic sensing.

2. Description of the Related Art

In a hard disk drive (HDD), the spacing between a magnetic recording head and magnetic storage disk, referred to as “head clearance,” is a critical performance parameter. Reducing head clearance during reading and writing operations can reduce bit error rate and allow accurate storage and retrieval of data that are stored on a disk at very high linear densities. Dynamic fly-height (DFH) control of read/write (R/W) elements is commonly used by modern HDDs to control the separation between the R/W element and the disk. DFH allows the low fly-heights necessary for high-density storage media while maintaining sufficient head clearance over different head locations and drive temperatures to prevent undue risk of physical contact between the R/W element and the disk surface, which can damage the head, the slider, or the disk surface and erase or otherwise corrupt user data.

The DFH control mechanism usually consists of a heating coil that is near the R/W element. When current is supplied to the DFH heating coil, a portion of the slider expands, moving the R/W elements closer to the disk surface. For proper operation of an HDD, DFH control schemes generally require some form of calibration to determine how the fly-height of a R/W element varies with stroke location, temperature, and applied DFH control signal, also referred to as DFH power.

One step in calibrating DFH control is determination of touchdown, i.e., when the R/W element actually makes contact with the storage medium. During normal operation such contact is avoided, but as part of calibration, touchdown provides an absolute benchmark of R/W element position relative to a disk, and is used in subsequent calibration procedures. For calibration at a given stroke location, the DFH control signal is stepped through increasing values until a portion of the R/W element begins to contact the disk, thereby providing the touchdown power at that stroke location. When such touchdown calibrations are performed at multiple temperatures, it is possible to determine the touchdown power as a function of temperature for a given R/W element. Thus, when the HDD temperature is known, i.e., when a thermal sensor is disposed in the HDD, the touchdown power for a given R/W element can be estimated at any time during normal drive operation as a function of temperature and stroke location.

Another step in calibrating DFH control involves determining the DFH power required to produce the desired separation between an R/W element and disk. Harmonic sensing is often used for this calibration. Harmonic sensing uses the change in the ratio between two different harmonics of a reference signal written on a disk to quantify the magnetic separation between the R/W element and the disk. As DFH power varies, the ratio between the two harmonics of the reference signal also changes, and the magnetic separation can then be determined at each applied DFH power based on the change in this ratio.

Thus, given the above calibrations for touchdown power and magnetic separation, a DFH control algorithm can regulate the fly-height accurately for a R/W element as a function of stroke location and drive temperature. However, other factors besides drive temperature and stroke location are known to significantly affect fly-height, e.g., atmospheric pressure and humidity. Unless sensors for monitoring every significant source of variation in fly-height are incorporated into the HDD, factory calibration alone is not able to compensate for the effects of altitude, humidity, or other factors. Instead, the nominal fly-height for an R/W element must be increased to allow for such fly-height variation, which adversely affects HDD performance.

In light of the above, there is a need in the art for a method of fly-height management in an HDD that can accurately compensate for variations in fly-height caused by environmental and other factors not directly measured in the HDD, such as changes in atmospheric pressure and humidity.

### SUMMARY OF THE INVENTION

One or more embodiments of the invention contemplate a method for managing fly-height of a recording head with respect to a recording medium, that allows compensation for variations in fly-height caused by environmental or other factors that are not directly measured in a hard disk drive (HDD). The method includes adjusting a dynamic fly-height (DFH) so that a target magnetic separation between the recording head and the recording medium is achieved. The target magnetic separation is determined based on the operating temperature of the HDD. In addition, different target magnetic separations may be determined for different radial locations of the recording medium, and for different heads within a disk drive.

A method of adjusting a fly-height of the recording head, according to an embodiment of the invention, includes the steps of measuring a magnetic separation between the recording head and the recording medium using harmonic sensing, measuring an operating temperature of the disk drive, determining a target magnetic separation based on the measured operating temperature, and adjusting a dynamic fly-height power that is applied to the recording head to achieve the target magnetic separation.

A method of adjusting a fly-height of the recording head as a function of temperature and recording medium location, according to an embodiment of the invention, includes the steps of measuring an operating temperature of the disk drive, determining a radial location of the recording head, determining a target magnetic separation based on the measured operating temperature and the radial location of the recording head, and adjusting a dynamic fly-height power that is applied to the recording head to achieve the target magnetic separation.

A disk drive, according to an embodiment of the invention includes a recording head, a recording medium, and a dynamic fly-height controller for measuring a magnetic separation between the recording head and the recording medium using harmonic sensing and adjusting dynamic fly-height power that is applied to the recording head based on the measured magnetic separation and a target magnetic separation that varies as a function of temperature and recording medium location.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a disk drive.

FIG. 2 illustrates a magnetic storage disk with data organized in a typical manner well known in the art.

FIG. 3 is a schematic side view of a read/write element positioned over a surface of magnetic storage disk.

FIG. 4 is a graph of the harmonic-sensed magnetic separation, measured at touchdown, of a read/write element and a recording medium, as a function of temperature.

FIG. 5 is a flow chart summarizing a method of fly-height management in an HDD using harmonic sensing of magnetic spacing, according to an embodiment of the invention.

For clarity, identical reference numbers have been used, where applicable, to designate identical elements that are common between figures. It is contemplated that features of one embodiment may be incorporated in other embodiments without further recitation.

### DETAILED DESCRIPTION

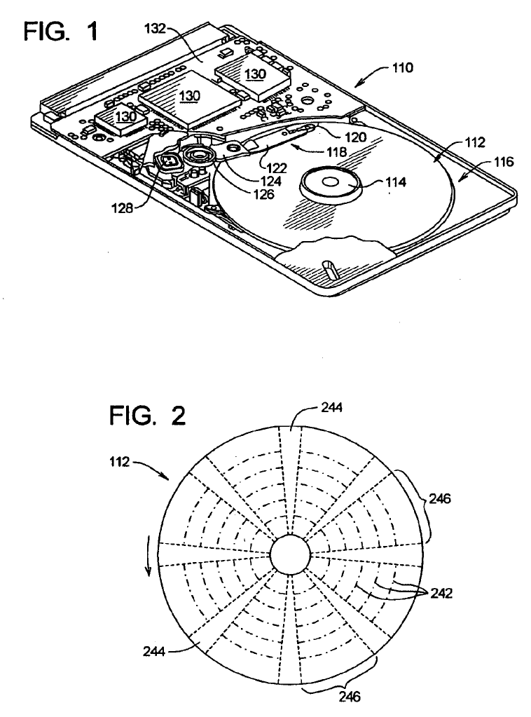

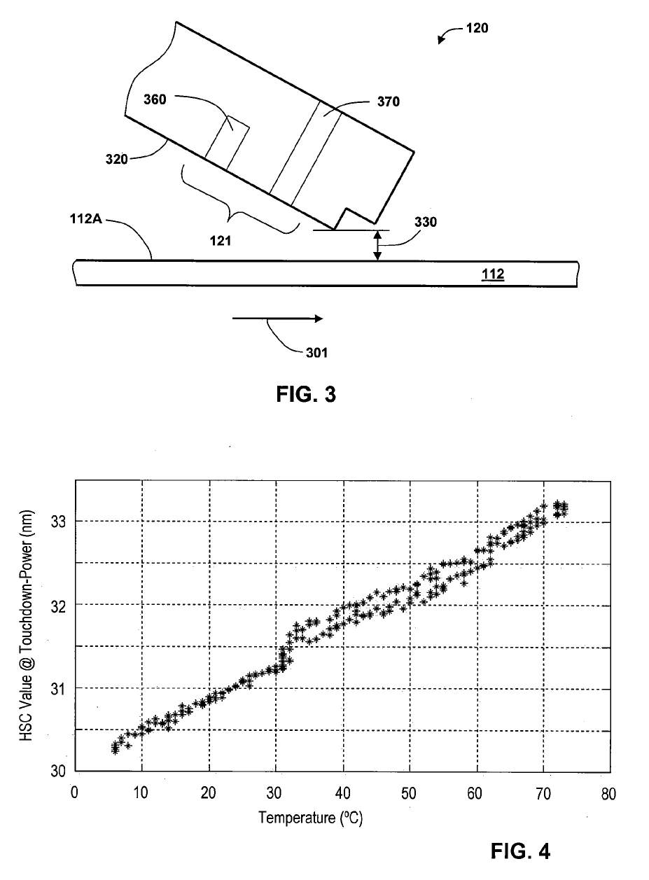

FIG. 1 is a perspective view of a disk drive 110 that can benefit from embodiments of the invention as described herein. For clarity, disk drive 110 is illustrated without a top cover. Disk drive 110 includes a magnetic storage disk 112 that is rotated by a spindle motor 114. Spindle motor 114 is mounted on a base plate 116. An actuator arm assembly 118 is also mounted on base plate 116, and has a slider 120 mounted on a flexure arm 122 and having a read/write (R/W) head 121 (illustrated in FIG. 3) lithographically constructed thereon. Flexure arm 122 is attached to an actuator arm 124 that rotates about a bearing assembly 126. Voice coil motor 128 moves slider 120 relative to magnetic storage disk 112, thereby positioning R/W head 121 over the desired concentric data storage track disposed on the surface 112A of magnetic storage disk 112. Spindle motor 114, R/W head 121, and voice coil motor 128 are coupled to electronic circuits 130, which are mounted on a printed circuit board 132. The electronic circuits 130 include a read channel, a microprocessor-based controller, and random access memory (RAM). For clarity of description, disk drive 110 is illustrated with a single magnetic storage disk 112 and actuator arm assembly 118. However, disk drive 110 may also include multiple disks 112 and multiple actuator arm assemblies 118.

FIG. 2 illustrates magnetic storage disk 112 with data organized in a typical manner well known in the art. Magnetic storage disk 112 includes concentric data storage tracks 242 for storing data. Each of concentric data storage tracks 242 is schematically illustrated as a centerline, however each of concentric data storage tracks 242 occupies a finite width about a corresponding centerline. Magnetic storage disk 112 includes radially aligned servo spokes 244, also referred to as servo wedges, that cross concentric data storage tracks 242 and store servo information in servo sectors in concentric data storage tracks 242. Such servo information includes a reference signal, such as a square wave of known amplitude, that allows harmonic sensing of the magnetic separation between R/W head 121 and surface 112A in FIG. 1. In addition, the servo information is read by R/W head 121 during read and write operations to position R/W head 121 above a desired track 242. For clarity, a small number of concentric data storage tracks 242 and servo spokes 244 are shown. Typically, the actual number of concentric data storage tracks 242 and servo spokes 244 included on magnetic storage disk 112 is considerably larger. In a disk drive that uses a rotary actuator, the servo wedges occupy arc-shaped regions on the disk, the arc being described by the motion of the R/W head across the stroke as the actuator rotates about its pivot. The wedges are drawn as radial, pie-shaped regions in FIG. 2 for simplicity.

FIG. 3 is a schematic side view of slider 120 positioned over surface 112A of magnetic storage disk 112. Slider 120 includes R/W head 121 having a read head 360 and a write head 370, and an air-bearing surface (ABS) 320, which faces toward surface 112A of magnetic storage disk 112. The rotation of magnetic storage disk 112 in the direction of arrow 301 generates an air bearing between ABS 320 of R/W head 121 and surface 112A. The air bearing counterbalances the slight spring force produced by the suspension of flexure arm 122, thereby holding R/W head 120 a small, substantially constant fly-height 330 above surface 112A. With the high linear densities now in use for data storage on modern HDDs, fly-height 330 is commonly less than 10 nanometers and may be as small as 3 nanometers.

In operation, a thermal or mechanical fly-height actuator (not shown) disposed on slider 120 varies the vertical position of R/W head 121 over surface 112A as necessary to maintain a desired fly-height 330. The fly-height actuator is controlled by a fly-height controller contained in electronic circuits 130. The fly-height controller steps R/W head 121 incrementally closer to or farther from surface 112A by increasing or decreasing the DFH control signal applied to the fly-height actuator, where the DFH control signal is measured in digital-to-analog converter (DAC) counts. For example, when the applied DFH control signal is at a minimum, i.e., zero DAC counts, fly-height 330 is at its maximum value. The object of a touchdown determination algorithm is to quantify the number of DAC counts applied to the fly-height actuator that result in actual or imminent contact between R/W head 121 and surface 112A. Similarly, magnetic separation is determined at each applied DFH power using harmonic sensing in order to quantify the number of DAC counts applied to the fly-height actuator to produce the desired physical separation between R/W head 121 and surface 112A, i.e., to position R/W head 121 the desired distance above the point of touchdown.

As stated above, it is known that touchdown power varies with the temperature of an HDD, which is why touchdown calibrations are performed at multiple temperatures when factory calibrating an HDD. Likewise, the use of harmonic sensing to measure magnetic separation between a R/W element and a recording medium is also known in the art. However, the inventor has determined that magnetic separation at or near the point of touchdown, as determined using harmonic sensing, is not constant, and in many HDDs varies as a function of HDD temperature.

FIG. 4 is a graph of the harmonic-sensed magnetic separation, measured at touchdown, of a R/W element and a recording medium, as a function of temperature. Two separate runs were measured and, as shown, the harmonic-sensed magnetic separation, referred to in the plot as “HSC Value @ Touchdown,” varies by approximately 3 nm over each run as the HDD temperature varies between 10 and 70 degrees C. This indicates that, given the same harmonic-sensed magnetic separation, a R/W element will be disposed a different distance from touchdown, depending on temperature. In the example illustrated in FIG. 4, such temperature-based variation can be as much as 3 nm—a significant error in vertical positioning for a modern HDD. Consequently, the use of a fixed value for a target magnetic separation for a given disk drive will inherently contain vertical positioning error at most temperatures, and therefore cannot be relied on to accurately determine the position of a R/W element above a disk over a range of operating temperatures.

The inventor has further determined that the temperature-dependence of harmonic-sensed magnetic spacing is approximately linear with respect to temperature, as illustrated in FIG. 4. In addition, the slope of said linear relationship varies significantly between different HDD designs and, in some cases, between individual drives of the same design. Further, the slope of the temperature-dependence of harmonic-sensed magnetic spacing may also vary between different heads in the same HDD. According to embodiments of the invention, by quantifying the temperature-dependence of harmonic-sensed magnetic spacing as part of the initial drive calibration procedure, harmonic-sensed magnetic spacing can subsequently be used throughout the life of an HDD to directly estimate the position of a R/W element with respect to a disk surface. In this way, for each head in a particular HDD, the effect of factors that may produce significant fly-height variation, such as atmospheric pressure and humidity, can be detected and compensated for. Otherwise, such fly-height variation must be included in the nominal fly-height budget of the HDD, resulting in a higher nominal fly-height, or each such factor must be measured directly with a dedicated sensor and fly-height then corrected in an open-loop fashion by consulting a calibration table quantifying the behavior of the HDD at the measured value. Thus, according to embodiments of the invention, a control algorithm may be constructed for controlling fly-height, in which actual fly-height is estimated based on the harmonic-sensed magnetic spacing of a R/W element and is periodically adjusted accordingly.

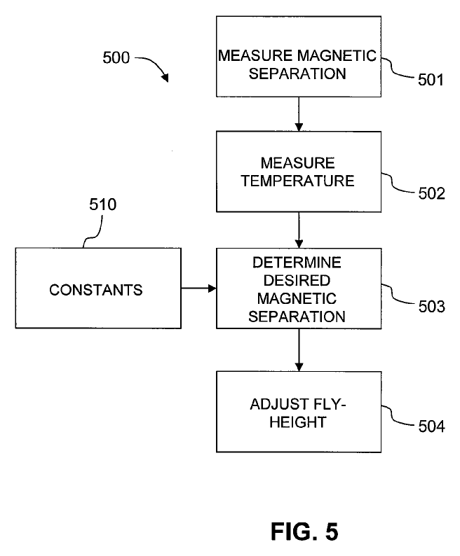

FIG. 5 is a flow chart summarizing a method 500 of fly-height management in an HDD using harmonic sensing of magnetic spacing, according to an embodiment of the invention. For ease of description, method 500 is described in terms of an HDD substantially similar to disk drive 110 in FIG. 1, however other HDDs may also benefit from the use of method 500. The commands for carrying out steps 501-504 may reside in the HDD control algorithm and/or as values stored in the electronic circuits of the HDD or on the magnetic storage disk itself. Method 500 depends on information collected during factory calibration of the HDD, including touchdown calibration data and DFH power calibration using harmonic sensing.

As part of factory calibration of the HDD, touchdown calibration is performed over a range of temperatures for each R/W element in the HDD. The specific temperatures at which each touchdown calibration is performed to accurately establish touchdown power as a function of temperature can vary, as can the number of different temperatures. One of skill in the art can readily determine at what specific temperatures and how many different temperatures a touchdown calibration is performed, depending on the particular HDD design being calibrated.

In one embodiment, a touchdown calibration test may be performed at one temperature near the minimum operating temperature of the HDD, e.g., 15° C., at one temperature near the maximum operating temperature of the HDD, e.g., 60° C., and at one temperature somewhere in between, e.g., 35° C. In such an embodiment, interpolation and/or a best-fit curve may be used to define the touchdown power at other temperatures. Alternatively, a touchdown test may be performed on the order of every one or two degrees C. between the maximum and minimum operating temperatures of the HDD, in which case interpolation or other estimating methods may be unnecessary. In one embodiment, a battery of multiple touchdown calibrations is performed at multiple locations on the magnetic storage disk, i.e., at different stroke locations for each actuator arm. For example, touchdown calibrations may be performed at a point near the inner diameter, the outer diameter, and/or a center point approximately equidistant from the inner and outer diameters.

Also as part of factory calibration of the HDD, harmonic sensing is used to determine the DFH power that results in the magnetic separation that corresponds to a target distance beyond the magnetic separation at touchdown, where the target distance is the desired distance between a R/W element and the surface of the disk. As is known in the art, harmonic sensing of magnetic separation, which is related but not equivalent to fly-height, is determined by reading a reference signal on the disk having a known frequency. The reference signal may be a square-wave signal written to system-cylinders or to servo spokes on the disk and therefore resides outside the user-accessible regions of the disk. The signal is processed to determine the spectral magnitude at two different frequencies, e.g., the first and third harmonics of the original square-wave signal. Because the third-harmonic amplitude falls more quickly with distance from the magnetic surface than the first harmonic amplitude, changes in the ratio between the two harmonic amplitudes indicate changes in the magnetic separation of the R/W element from the magnetic recording layer on the disk, which in turn is related to the physical separation of the lowermost portion of the slider from the surface of the disk.

As noted above in conjunction with FIG. 4, the target magnetic separation, as determined using the above-described harmonic sensing, is not constant and varies as a function of HDD temperature. Therefore, as part of factory calibration, a harmonic sensing procedure is conducted at multiple temperatures for each R/W element to generate a number of constant-value inputs used during step 503 of method 500, described below. The constant-value inputs so generated include the target harmonic-sensed magnetic separation at various temperatures and locations. This procedure is analogous to the touchdown calibration procedure set forth above, in which the temperature-dependence of touchdown power is established via touchdown measurements taken over a range of temperatures and locations. As with the touchdown calibration, the specific temperatures at which each target magnetic separation calibration is performed can vary, as can the number of different temperatures. One of skill in the art can readily determine at what and how many temperatures the target magnetic separation is measured to generate the constant-value inputs for accurately establishing touchdown power as a function of temperature in step 503 of method 500. In one embodiment, the target magnetic separation calibration is performed at multiple locations on the magnetic storage disk, i.e., at different stroke locations for each actuator arm. For example, touchdown calibrations may be performed at a point near the inner diameter, the outer diameter, and/or a center point approximately equidistant from the inner and outer diameters.

In step 501, harmonic sensing as set forth above is used in the HDD to determine the magnetic separation of each R/W head in the HDD.

In step 502, the temperature of the HDD is measured using a thermistor or other temperature-measuring apparatus positioned in the HDD.

In step 503, the desired, or target, magnetic separation for a R/W head is determined. According to embodiments of the invention, the target magnetic separation is not a constant value, but instead is a function of temperature and, optionally, location. The relationship between target magnetic separation and temperature may be described by a linear or a higher order function.

In one embodiment, the target magnetic separation is specified as a function of temperature and radius by Equations 1 and 2, which assume that target magnetic separation varies linearly with temperature and location.

MS_{ID}(T)=MS_{ID,Cold}+(MS_{ID,Hot}−MS_{ID,Cold})*(T−T_{Cold})/(T_{Hot}−T_{Cold}) (1)

MS_{OD}(T)=MS_{OD,Cold}+(MS_{OD,Hot}−MS_{OD,Cold})*(T−T_{Cold})/(T_{Hot}−T_{Cold}) (2)

### Where:

MS_{ID, Cold} is the target harmonic-sensed magnetic separation at the inner diameter of the magnetic disk at a selected low temperature;
MS_{ID, Hot} is the target harmonic-sensed magnetic separation at the inner diameter of the magnetic disk at a selected high temperature;
MS_{OD, Cold} is the target harmonic-sensed magnetic separation at the outer diameter of the magnetic disk at the selected low temperature;
MS_{OD, Hot} is the target harmonic-sensed magnetic separation at the outer diameter of the magnetic disk at the selected high temperature;
T_{Hot} is the selected high temperature; and
T_{Cold} is the selected high temperature.

In such an embodiment, a total of four parameters are measured as part of factory calibration of the HDD, i.e., MS_{ID, Cold}, MS_{ID, Hot}, MS_{OD, Cold}, and MS_{OD, Hot}, and Equations 1 and 2 are used in step 503 to determine the target magnetic separation. In another embodiment, a non-linear relationship between target magnetic separation and temperature may be described by Equations 1 and 2, depending on the particular HDD design being calibrated. For example, a best-fit curve may be generated to describe the temperature-dependence of harmonic-sensed magnetic spacing. In yet another embodiment, a system of more than 2 equations may be employed to determine the value of target magnetic separation at any location and temperature, for example a third equation corresponding to the midpoint between the inner and outer diameters. In the three-equation example of such an embodiment, two additional parameters are measured as part of factory calibration of the HDD, i.e., MS_{Midpont, Cold}, MS_{Midpoint, Hot}, etc. Alternatively, during factory calibration more data points may be measured than just at the inner and outer diameter, to better reflect non-linear relationships and/or for higher accuracy of Equations 1 and 2.

The target magnetic separation at an arbitrary radius is determined using Equation 3:

MS(T,r)=MS_{ID}(T)+(MS_{OD}(T)−MS_{ID}(T))*(r−r_{ID})/(r_{OD}−r_{ID}) (3)

### Where

MS(T, r) is the target harmonic-sensed magnetic separation at radius r of the magnetic disk and at temperature T;
MS_{ID}(T) is the target harmonic-sensed magnetic separation at the inner diameter of the magnetic disk at temperature T;
MS_{OD}(T) is the target harmonic-sensed magnetic separation at the outer diameter of the magnetic disk at temperature T;
r_{ID} is the ID radius; and
r_{OD} is the OD radius.

The value of magnetic separation measured in step 501 is then compared to the target magnetic separation value for each R/W head as determined with Equations 1 and 2 in step 503. For locations between the inner diameter and outer diameter, the target magnetic separation may be interpolated from the values of target magnetic separation using Equation 3.

In step 504, the DFH power is adjusted using methods known to those skilled in the art to increase or decrease fly-height so as to achieve the target magnetic separation. Steps 501 and 504 may be repeated as needed to confirm that the target magnetic separation has been achieved.

Method 500 may be performed as part of initial factory calibration, but may also be performed periodically throughout the life of the HDD to beneficially correct for variations in fly-height caused by factors besides temperature, such as changes in atmospheric pressure and humidity. For example, the HDD may perform method 500 whenever the HDD is started up and/or has been in operation for a predetermined time interval, e.g., once every hour, etc. In addition, method 500 may be performed whenever a read/write or other error has occurred in the HDD.

To minimize the amount of offline time for the HDD, the number of measurements that are conducted in Step 501 may be reduced, thereby lowering any potential impact on drive performance. In one embodiment, measurements are only taken at the outer diameter, since the temperature-dependence of magnetic separation has been observed to be the greatest at this location and less important at the inner diameter. In such an embodiment, the temperature-dependence of magnetic separation at the inner diameter may be assumed to be zero or some other relatively small, constant value, which may be determined for each HDD design. In another embodiment, instead of interpolating between two or more equations to determine the target magnetic separation as a function of radius and temperature, measurement of magnetic separation is taken at a single point on a single R/W head. In such an embodiment, the difference between the target and measured magnetic separation is used as an indication of deviation of atmospheric pressure from the atmospheric pressure present during factory calibration, and DFH power for all heads is modified based on this atmospheric pressure deviation. This embodiment assumes that a change in atmospheric pressure is chiefly responsible for the variation in fly-height. In another embodiment, determination of the DFH power necessary to achieve the target magnetic separation at a single location on a single R/W head may be taken as an indication of the air-pressure/humidity conditions that the HDD is currently being subjected to, and adjustments are made to the DFH-power applied to that R/W head at other locations, and/or to other R/W heads accordingly. For greater accuracy in such an embodiment, factory calibration of the HDD may include the HDD making magnetic separation measurements on all heads at low atmospheric pressure at one or more locations to quantify the effect of low atmospheric pressure on fly-height for each R/W head. Alternatively, such magnetic separation measurements may be performed on all heads the first time the HDD determines that it is operating at low atmospheric pressure, rather than as part of factory calibration.

In one embodiment, the DFH power necessary to achieve the target magnetic separation is determined for all R/W heads in an HDD by using the harmonic-sensed magnetic spacing of a single R/W element as a reference for the remaining R/W heads in the HDD and adjusting the position of each remaining head accordingly. The temperature-dependent behavior of the remaining R/W heads with respect to the reference R/W head is based on measurements taken during factory calibration of the HDD. For example, factory calibration of an HDD may reveal that the slope of the temperature-dependence of the harmonic-sensed magnetic spacing for a second R/W head may be 10% greater than the slope for the reference R/W head. Rather than periodically performing harmonic-sensed magnetic spacing measurements for both the reference R/W and the second R/W head, actual fly-height of the second R/W head may be adjusted based on the known relationship between the temperature-dependent behavior of the second R/W head with respect to the reference R/W head, i.e., the second R/W head has a 10% greater slope. In another embodiment, harmonic-sensed magnetic spacing measurements are performed periodically for each R/W head in the HDD in order to adjust the actual fly-height for each R/W head.

While the foregoing is directed to embodiments of the present invention, other and further embodiments of the invention may be devised without departing from the basic scope thereof, and the scope thereof is determined by the claims that follow.

I claim:

1. In a disk drive having a recording head and a recording medium, a method of adjusting a fly-height of the recording head, comprising the steps of:
measuring a magnetic separation between the recording head and the recording medium using harmonic sensing;
measuring an operating temperature of the disk drive;
determining a target magnetic separation based on the measured operating temperature, wherein the target magnetic separation varies with the operating temperature such that a target magnetic separation at a first operating temperature is different from a target magnetic separation at a second operating temperature; and
adjusting a dynamic fly-height power that is applied to the recording head to achieve the target magnetic separation.

2. The method according to claim 1, wherein the target magnetic separation is determined using dynamic fly-height calibration data.

3. The method according to claim 2, wherein the dynamic fly-height calibration data include at least two values of target magnetic separation, the first value corresponding to the target magnetic separation at a first operating temperature and the second value corresponding to the target magnetic separation at a second operating temperature.

4. The method according to claim 3, wherein the target magnetic separation is determined based on a function that is derived from the dynamic fly-height calibration data.

5. The method according to claim 4, wherein the function is an interpolation function.

6. The method according to claim 1, further comprising the steps of:
measuring a magnetic separation between the recording head and the recording medium using harmonic sensing at a different radius of the recording medium;
determining a target magnetic separation at the different radius of the recording medium based on the measured operating temperature, wherein the target magnetic separation at the different radius of the recording medium varies with the operating temperature such that a target magnetic separation at the different radius of the recording medium at a first operating temperature is different from a target magnetic separation at the different radius of the recording medium at a second operating temperature; and
adjusting a dynamic fly-height power that is applied to the recording head to achieve the target magnetic separation at the different radius of the recording medium.

7. The method according to claim 6, wherein the disk drive includes a memory unit that stores at least four values of target magnetic separation, the first value corresponding to the target magnetic separation at a first operating temperature and a first radius of the recording medium, the second value corresponding to the target magnetic separation at the first operating temperature and a second radius of the recording medium, the third value corresponding to the target magnetic separation at a second operating temperature and the first radius of the recording medium, and the fourth value corresponding to the target magnetic separation at the second operating temperature and the second radius of the recording medium.

8. In a disk drive having a recording head and a recording medium, a method of adjusting a fly-height of the recording head as a function of temperature and recording medium location, comprising the steps of:
measuring an operating temperature of the disk drive;
determining a radial location of the recording head;
determining a target magnetic separation based on the measured operating temperature and the radial location of the recording head; and
adjusting a dynamic fly-height power that is applied to the recording head to achieve the target magnetic separation.

9. The method according to claim 8, further comprising the step of measuring a magnetic separation between the recording head and the recording medium using harmonic sensing, wherein the dynamic fly-height power is adjusted with reference to both the measured magnetic separation and the target magnetic separation.

10. The method according to claim 9, wherein the magnetic separation between the recording head and the recording medium is measured another time after the dynamic fly-height power has been adjusted to confirm that the target magnetic separation has been achieved.

11. The method according to claim 10, wherein, if it is not confirmed that the target magnetic separation has been achieved, adjusting the dynamic fly-height power another time.

12. The method according to claim 8, wherein the target magnetic separation is determined using dynamic fly-height calibration data.

13. The method according to claim 12, wherein the dynamic fly-height calibration data include at least four values of target magnetic separation, the first value corresponding to the target magnetic separation at a first operating temperature and a first radial location of the recording medium, the second value corresponding to the target magnetic separation at the first operating temperature and a second radial location of the recording medium, the third value corresponding to the target magnetic separation at a second operating temperature and the first radial location of the recording medium, and the fourth value corresponding to the target magnetic separation at the second operating temperature and the second radial location of the recording medium.

14. The method according to claim 13, wherein the target magnetic separation is determined based on a function that is derived from the dynamic fly-height calibration data.

15. The method according to claim 14, wherein the function is an interpolation function.

16. A disk drive, comprising:
a recording head;
a recording medium; and
a dynamic fly-height controller for measuring a magnetic separation between the recording head and the recording medium using harmonic sensing and adjusting dynamic fly-height power that is applied to the recording head based on the measured magnetic separation and a target magnetic separation that varies as a function of temperature and recording medium location.

17. The disk drive according to claim 16, further comprising a memory unit for storing at least two values of target magnetic separation, the first value corresponding to the target magnetic separation at a first operating temperature of the disk drive and the second value corresponding to the target magnetic separation at a second operating temperature of the disk drive.

18. The disk drive according to claim 17, further comprising a temperature measurement unit.

19. The disk drive according to claim 16, further comprising a memory unit for storing at least four values of target magnetic separation, the first value corresponding to the target magnetic separation at a first operating temperature and a first radial location of the recording medium, the second value corresponding to the target magnetic separation at the first operating temperature and a second radial location of the recording medium, the third value corresponding to the target magnetic separation at a second operating temperature and the first radial location of the recording medium, and the fourth value corresponding to the target magnetic separation at the second operating temperature and the second radial location of the recording medium.

20. The disk drive according to claim 19, further comprising a temperature measurement unit.
